(19) United States
(12) Patent Application Publication
(10) Pub. No.: US 2007/0279004 A1
(43) Pub. Date: Dec. 6, 2007

(54) Portable charging system

(75) Inventors: Ligong Wang, Round Rock, TX (US); John J. Breen, Harker Heights, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 11/437,350

(22) Filed: May 19, 2006

(51) Int. Cl. H02J 7/00

(52) U.S. Cl. 320/128

(57) ABSTRACT

For charging rechargeable battery packs, an alternating current (AC) to direct current (DC) adapter receives an AC input and provides an AC available signal indicative of the presence of the AC input. A controller selectively provides the AC available signal to a selected one of the battery packs. The selected one of the battery packs, which has a charge level below a threshold, asserts a charge switch to enable the charging. The controller directs a charger coupled to the AC-DC adapter to initiate the charging of the selected one to a predefined level.

### BACKGROUND

The present disclosure relates generally to information handling systems, and more particularly to charging rechargeable batteries powering portable information handling systems.

As the value and use of information continues to increase, individuals and businesses seek additional ways to process and store information. One option is an information handling system (“IHS”). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

A battery converts chemical energy within its material constituents into electrical energy in the process of discharging. A rechargeable battery (may be simply referred to as a battery) is generally returned to its original charged state (or substantially close to it) by a charger circuit, which passes an electrical current in the opposite direction to that of the discharge. Presently, well known rechargeable battery technologies include Lithium Ion (LiON), Nickel Cadmium (NiCd), and Nickel Metal Hydride (NiMH).

However, traditional charging circuits often deploy complex circuitry having multiple components. For example, multiple metal oxide field effect transistor (MOSFET) switches located on the motherboard of the IHS as well as within the battery packs may be coupled in series to control the charging process. Having an increased component count often results in higher costs, less efficient use of available power and space, and reduced reliability. Therefore, a need exists for an improved method and system to charge a battery pack while maintaining control and ensuring safety during the charging process. Accordingly, it would be desirable to provide a method and system for a more efficient charging system included in an IHS, absent the disadvantages found in the prior methods discussed above.

### SUMMARY

The foregoing need is addressed by the teachings of the present disclosure, which relates to charging rechargeable battery packs. According to one embodiment, an alternating current (AC) to direct current (DC) adapter receives an AC input and provides an AC available signal indicative of the presence of the AC input. A controller selectively provides the AC available signal to a selected one of the battery packs. The selected one of the battery packs, which has a charge level below a threshold, asserts a charge switch to enable the charging. The controller directs a charger coupled to the AC-DC adapter to initiate the charging of the selected one to a predefined level.

In one aspect, charging rechargeable battery packs includes receiving an AC available signal indicative of a presence of an AC input. A low charge signal is received from at least one of the rechargeable battery packs. The AC available signal is communicated to a selected one of the rechargeable battery packs for enabling the charging. The charging is directed to the selected one in response to communicating the AC available signal.

Several advantages are achieved according to the illustrative embodiments presented herein. The embodiments advantageously provide a reduction in components used in the charging of battery packs while maintaining control and ensuring safety during the charging process. Having a reduced component count to perform the charging function advantageously results in lower costs, more efficient use of available power and space, and improved reliability. Thus, the embodiments increase user experience while reducing product costs.

### BRIEF DESCRIPTION OF THE DRAWINGS

FIG. 1 illustrates a block diagram of an IHS, according to an embodiment.

FIG. 2 illustrates a block diagram of a power supply system for charging battery packs, according to an embodiment.

FIG. 3 is a flow chart illustrating a method for charging battery packs, according to an embodiment.

### DETAILED DESCRIPTION

Novel features believed characteristic of the present disclosure are set forth in the appended claims. The disclosure itself, however, as well as a preferred mode of use, various objectives and advantages thereof, will best be understood by reference to the following detailed description of an illustrative embodiment when read in conjunction with the accompanying drawings. The functionality of various circuits, devices, boards, cards, modules, blocks, and/or components described herein may be implemented as hardware (including discrete components, integrated circuits and systems-on-a-chip ‘SOC’), firmware (including application specific integrated circuits and programmable chips) and/or software or a combination thereof, depending on the application requirements.

As described earlier, traditional charging circuits often deploy complex circuitry having multiple components. For example, multiple MOSFET switches located on the motherboard of the IHS as well as within the battery packs may be coupled in series to control the charging process. Having an increased component count often results in higher costs, less efficient use of available power and space, and reduced reliability. Therefore, a need exists for an improved method and system to charge a battery pack while maintaining control and ensuring safety during the charging process. According to one embodiment, in a method and system for charging rechargeable battery packs, an AC to DC adapter receives an AC input and provides an AC available signal indicative of the presence of the AC input. A controller selectively provides the AC available signal to a selected one of the battery packs. The selected one of the battery packs, which has a charge level below a threshold, asserts a charge switch to enable the charging. The controller directs a charger coupled to the AC-DC adapter to initiate the charging of the selected one to a predefined level.

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, the IHS may be a personal computer, including notebook computers, personal digital assistants, cellular phones, gaming consoles, a network storage device, or any other suitable device and may vary in size, shape, performance, functionality, and price. The IHS may include random access memory (RAM), one or more processing resources such as central processing unit (CPU) or hardware or software control logic, read only memory (ROM), and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to receive/transmit communications between the various hardware components.

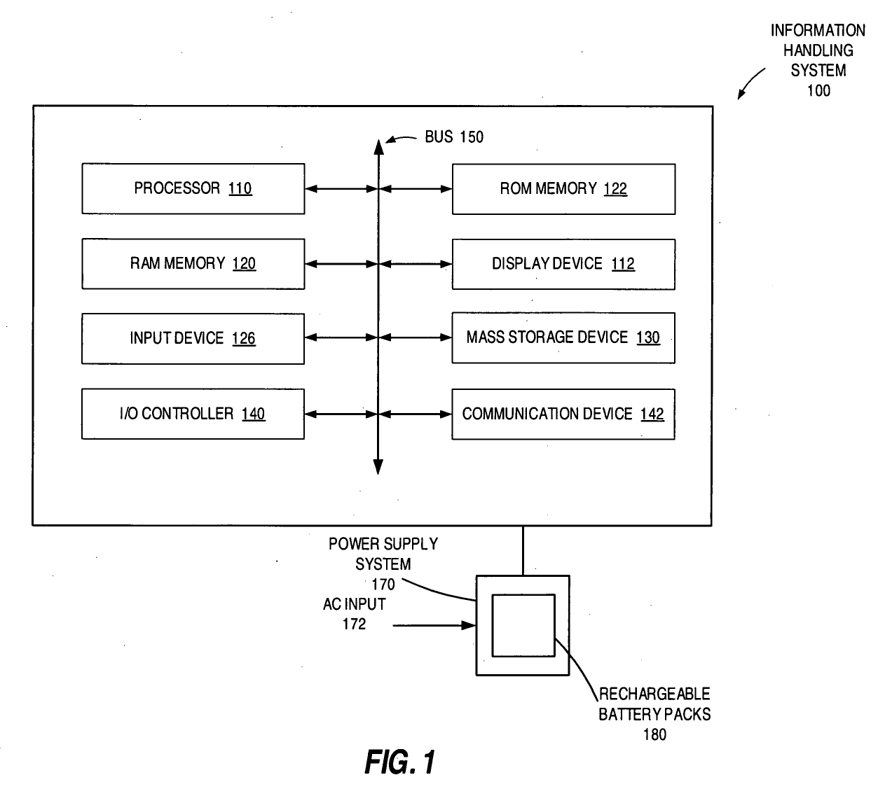

FIG. 1 illustrates a block diagram of an IHS 100, according to an embodiment. The IHS 100 includes a processor 110, which is coupled to a bus 150. The bus 150 serves as a connection between the processor 110 and other components of the IHS 100. An input device 126 is coupled to the processor 110 to provide input to the IHS 100. Examples of input devices may include keyboards, touchscreens, and pointing devices such as mouses, trackballs and trackpads. Software programs, including instructions, and data are stored on a mass storage device 130, which is coupled to processor 110 via the bus 150. Mass storage devices may include such devices as hard disks, optical disks, magneto-optical drives, floppy drives and the like. The IHS system 100 further includes a display device 112, which is coupled to the processor 110 by the bus 150. A system memory 120, which may also be referred to as RAM or main memory, is coupled to the processor 110 to provide the processor with fast storage to facilitate execution of computer programs by the processor 110. In an embodiment, a chassis (not shown) houses some or all of the components of IHS 100. It should be understood that other buses and intermediate circuits can be deployed between the components described above and processor 110 to facilitate interconnection between the components and the processor 110.

The IHS 100 may also include a non-volatile ROM 122 memory, an I/O controller 140 for controlling various other I/O devices. For example, the I/O controller 140 may include a serial I/O bus controller. It should be understood that the term “information handling system” is intended to encompass any device having a processor that executes instructions from a memory medium.

The IHS 100 is shown to include the mass storage device 130 connected to the processor 110, although some embodiments may not include the mass storage device 130. In a particular embodiment, the IHS 100 may include additional hard disks. The bus 150 may include data, address and control lines. In an exemplary, non-depicted embodiment, not all devices shown may be directly coupled to the bus 150. In one embodiment, the IHS 100 may include multiple instances of the bus 150. The multiple instances of the bus 150 may be in compliance with one or more proprietary standards and/or one or more industry standards such as peripheral component interconnect (PCI), PCI express (PCIe), industry standard architecture (ISA), universal serial bus (USB), system management bus (SMBus), and similar others. A communications device 142, such as a network interface card and/or a radio device, may be connected to the bus 150 to enable wired and/or wireless information exchange between the IHS 100 and other devices (not shown).

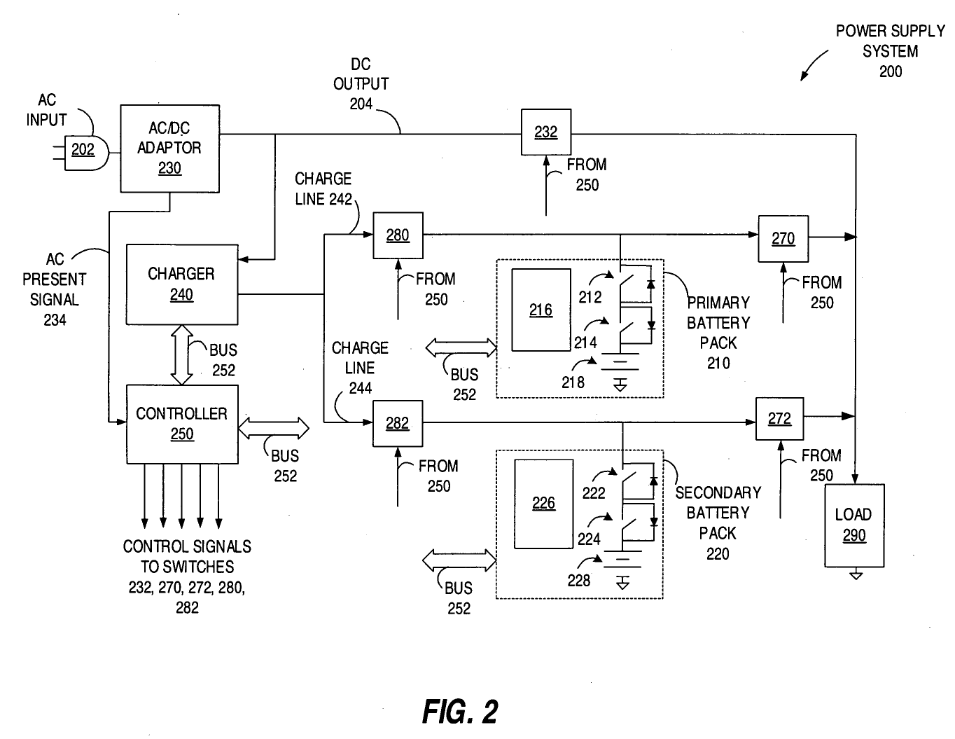

In a particular embodiment, the IHS 100 receives power from a power supply system 170, which includes rechargeable battery packs 180 (which may be simply referred to as the battery packs 180 or a plurality of battery packs 180). The power supply system 170 receives an AC input 172 such as 120/240 volts from an electrical wall outlet. When operating in a battery powered mode, the battery packs 180 provide the power to a load. The load may include one or more components of the IHS 100 such as the processor 110. The power supply system 170 and/or the battery packs 180 may communicate with one or more components of the IHS 100 via the SMbus (not shown). Additional detail of the technique for charging the battery packs 180 is described with reference to FIG. 2.

The processor 110 is operable to execute the instructions and/or operations of the IHS 100. The memory medium, e.g., RAM 120, preferably stores instructions (also known as a “software program”) for implementing various embodiments of a method in accordance with the present disclosure. An operating system (OS) (not shown) of the IHS 100 is a type of software program that controls execution of other software programs, referred to as application software programs. In various embodiments the instructions and/or software programs may be implemented in various ways, including procedure-based techniques, component-based techniques, and/or object-oriented techniques, among others. Specific examples include assembler, C, XML, C++ objects, Java and Microsoft's .NET technology.

FIG. 2 illustrates a block diagram of a power supply system 200 for charging a primary battery pack 210 and a secondary battery pack 220, according to an embodiment. In a particular embodiment, the power supply system 200 is substantially the same as the power supply system 170 and the combined primary and secondary battery packs 210 and 220 are substantially the same as the battery packs 180 described with reference to FIG. 1. In the depicted embodiment, the power supply system 200 includes an AC-DC adapter 230, a charger 240, a controller 250, the primary battery pack 210, the secondary battery pack 220 and a plurality of switches operable to direct the flow of power to a load 290, which may include the IHS 100 and/or components thereof.

The power supply system 200 receives an AC input 202 such as 120/240 volts from an electrical wall outlet. An AC-DC adapter 230 converts the AC input 202 to a DC output 204. A charger device 240 receives the DC output 204 and provides a charge to each one of the primary and secondary battery packs 210 and 220 via charge lines 242 and 244 respectively. A controller 250, which is included in the IHS 100, is operable to control various I/O of the IHS 100 as well as control I/O of the power supply system 200. In a particular embodiment, the controller 250 is substantially the same as the I/O controller 140 described with reference to FIG. 1. In an embodiment, the controller 250 is at least one of a keyboard controller (KBC), the I/O controller 140, and an embedded controller.

The primary battery pack 210 includes a primary charge switch 212 and a primary discharge switch 214 for enabling the charging and the discharging of the battery pack, a primary battery control circuit 216 for controlling the operation of the primary charge/discharge switches 212 and 214, and one or more primary rechargeable battery cells 218 for storing the charge for later use. Similarly, the secondary battery pack 220 includes a secondary charge switch 222 and a secondary discharge switch 214 for enabling the charging and the discharging of the battery pack, a secondary battery control circuit 226 for controlling the operation of the secondary charge/discharge switches 222 and 224, and one or more secondary rechargeable battery cells 228 for storing the charge for later use. Although the battery packs are shown to have two batteries in the depicted embodiment, additional batteries may be included. Also, any one of the battery packs may be configured to be the primary and another one the secondary.

The primary and secondary battery control circuits 216 and 226, and the controller 250 monitor battery related parameters such as the energy or charge level, voltage level and the current flowing through the primary and secondary rechargeable battery cells 218 and 228. Communications between the battery packs and the controller 250, and the charger 240 is via a bus 252 such as a SMBus. In the depicted embodiment, the controller 250 working in co-operation with various devices such as the AC-DC adapter 230, the charger 240, the primary battery pack 210 and the secondary battery pack 220 via the bus 252, directs the flow of power by opening and/or closing of the plurality of switches.

The plurality of switches includes a power source switch 232, primary and secondary battery discharge selector switches 270 and 272, and primary and secondary battery charge switches 280 and 282. Each switch of the plurality of switches is controlled by the controller 250 by asserting or de-asserting a corresponding control signal. The controller 250 detects an AC present signal 234 from the AC-DC adapter 230 when the AC input 202 is plugged in. In response to the AC present signal 234, the controller closes (asserts or turns on) the power source switch 232. In a particular embodiment, the body diode (not shown) of the primary and secondary battery charge switches 280 and 282 enables the charge current to flow and is independent of the open or closed status of the switches 280 and 282. When the battery packs are operating in a discharge mode, the controller 250 may open the primary and secondary battery charge switches 280 and 282 to ensure that current does not flow between batteries having different voltages.

In response to the AC present signal 234, the controller 250 determines which one of the primary battery pack 210 and the secondary battery pack 220 is selectable to receive the charge from the charger 240. The battery having a charge level that is below a threshold may be selected first to receive the charge. If both the primary battery pack 210 and the secondary battery pack 220 have a charge level that is below the threshold then the controller 250 may be configured to select the primary battery pack 210 first for the charging, followed by the secondary battery pack 220 upon completion of the charging of the primary battery pack 210. Other battery selection criteria, such as battery charge time, battery capacity and the like may also be used to determine the priority order of receiving the charge.

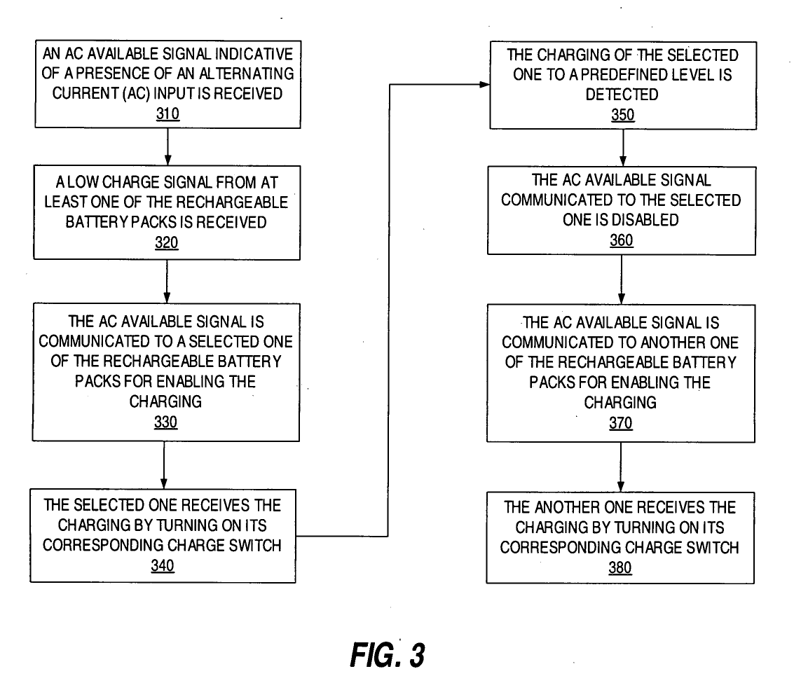

The controller 250 communicates the AC present signal 234 to the selected one of the battery packs, e.g., the primary battery pack 210 via the bus 252. In a particular embodiment, the controller 250 writes a particular value at a predefined memory location within the selected battery, e.g., within the primary battery control circuit 216, and reads back from the same memory location to determine a match for the written value. If a match is detected then the selected one of the battery packs turns on the corresponding charge switch, e.g., the primary charge switch 212, in response to receiving the AC present signal 234, and the selected one of the battery packs receives the charging. Thus, the power supply system 200 controls the charging process by communicating and co-coordinating charge conditions via the bus 252 and by utilizing only one charge switch, e.g., the primary charge switch 212 or the secondary charge switch 222, that is already present in most battery packs. Additional details of the method for charging the battery packs is described with reference to FIG. 3.

While being charged, the selected one of the battery packs may receive sufficient electrical energy or power to be stored for later use. In one embodiment, a sufficient amount of power is defined to be a charge level that is greater than 0% and up to and including 80% of relative state of charge (RSOC). A battery having a charge level of at least 80% of RSOC may be described to be at a first level of a fully charged status, while the battery having a charge level of less than 0% of RSOC or a cell voltage threshold 3.0V/2.5V may be described to be critically discharged.

In an embodiment, each one of the plurality of switches may be implemented using a MOSFET body diode. The MOSFET body diode is advantageously used to minimize the impact of an accidental reverse connection of the batteries and/or other over-current causing conditions.

FIG. 3 is a flow chart illustrating a method for charging battery packs, according to an embodiment. In a particular embodiment, the battery packs include the primary battery pack 210 and the secondary battery pack 220 described with reference to FIG. 2. At step 310, an AC available signal indicative of a presence of an AC input is received. At step 320, a low charge signal from at least one of the rechargeable battery packs is received indicating a charge level below a threshold. At step 330, the AC available signal is communicated to a selected one of the rechargeable battery packs for enabling the charging. In a particular embodiment, the AC available signal is communicated by writing to a memory location in the selected one of the battery packs and reading back from the same location. If a match is found then the selected one is operating normally. If no match is found then the selected battery may have a defect. At step 340, the selected one receives the charging by turning on its corresponding charge switch.

Various steps described above may be added, omitted, combined, altered, or performed in different orders. In a particular embodiment, additional steps may be performed to charge another one of the battery packs upon completion of the charging of the selected one to a predefined level. At step 350, the charging of the selected one to a predefined level is detected. At step 360, the AC available signal communicated to the selected one is disabled. At step 370, the AC available signal is communicated to another one of the rechargeable battery packs, e.g., the secondary battery pack 220, for enabling the charging. At step 380, the another one of the battery packs receives the charging by turning on its corresponding charge switch.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A charge system for charging battery packs, the charge system comprising:
an alternating current (AC) to direct current (DC) adapter operable to detect a presence of an AC input and provide an AC available signal indicative of the presence of the AC input; and
a controller operable to receive the AC available signal, provide the AC available signal to a selected one of the battery packs, and direct the charging to the selected one.

2. The charge system of claim 1 further comprising:
a charger coupled to the AC-DC adapter, the charger being operable to provide the charging.

3. The charge system of claim 1, wherein the selected one is at least one of a primary battery and a low charge battery, wherein the low charge battery has a charge level below a threshold.

4. The charge system of claim 1, wherein the controller directs the charging to another one of the battery packs in response to the charging of the selected one to a predefined level.

5. The charge system of claim 4, wherein the predefined level is approximately 80% of a relative state of charge (RSOC).

6. The charge system of claim 1, wherein the AC available signal is communicated to the selected one via a communications bus, wherein the communications bus is in accordance with a systems management bus (SMbus) standard.

7. The charge system of claim 1, wherein the controller is at least one of a keyboard controller, an input/output controller, and an embedded controller.

8. The charge system of claim 1, wherein the battery packs are in compliance with the smart battery system (SBS) specifications.

9. The charge system of claim 1, wherein the controller directs the charging to the selected one in response to the selected one having a charge level below a threshold, wherein the charging is enabled by the selected one by asserting a single charge switch of the selected one.

10. The charge system of claim 1, wherein each one of the battery packs except the selected one does not receive the AC available signal.

11. The charge system of claim 1, wherein each one of the battery packs is configured to turn on a corresponding charge switch only when a charge level of the selected one is below a predefined level and when the AC available signal is received.

12. A method for charging rechargeable battery packs, the method comprising:
receiving an AC available signal indicative of a presence of an AC input;
receiving a low charge signal from at least one of the rechargeable battery packs;
communicating the AC available signal to a selected one of the rechargeable battery packs for enabling the charging; and
directing the charging to the selected one.

13. The method of claim 12 further comprising:
detecting the charging of the selected one to a predefined level;
disabling the AC available signal communicated to the selected one;
communicating the AC available signal to another one of the rechargeable battery packs for enabling the charging; and
redirecting the charging from the selected one to the another one.

14. The method of claim 12, wherein the communicating occurs via a communications bus, wherein communications via the communications bus is in accordance with a SMbus standard.

15. The method of claim 12, wherein each one of the battery packs is configured for:
detecting a charge level that is below a predefined level;
receiving the AC available signal; and
asserting a corresponding charge switch to enable the charging.

16. An information handling system (IHS) comprising:
a processor;
an input/output (I/O) controller coupled to the processor;
a plurality of rechargeable battery packs operable to provide power to the processor and the I/O controller; and
a charging system operable to charge the plurality of rechargeable battery packs, wherein the charging system includes:
an AC-DC adapter operable set a AC available signal indicative of the presence of an AC input, wherein the I/O controller is operable to receive the AC available signal, provide the AC available signal to a selected one of the plurality of battery packs, and direct the charge to the selected one.

17. The system of claim 16 further comprising:
a charger coupled to the AC-DC adapter, the charger being operable to provide the charge.

18. The system of claim 16, wherein the controller directs the charge to another one of the plurality of battery packs in response to the selected one being charged to a predefined level.

19. The system of claim 18, wherein the predefined level is approximately 80% of a relative state of charge (RSOC).

20. The system of claim 16, wherein each one of the plurality of battery packs except the selected one does not receive the AC available signal.
